(19) United States
(12) Patent Application Publication
(10) Pub. No.: US 2005/0240691 A1
(43) Pub. Date: Oct. 27, 2005

(54) Vehicle media player unit

(75) Inventor: Alexander Yurusov, Taipei (TW)

Correspondence Address: ALEXANDER YURUSOV, 5F, NO. 17, HANG SHENG EAST ROAD, PANCHIAO, TAIPEI, 220, TW

(73) Assignee: Alexander Yurusov, Taipei (TW)

(21) Appl. No.: 10/709,266

(22) Filed: Apr. 26, 2004

(51) Int. Cl. G06F 13/10

(52) U.S. Cl. 710/62

(57) ABSTRACT

Vehicle media player unit based on removable hard disk drive is disclosed. Unit is capable to read digital media data stored in a hard disc drive, decode it into analog or digital audio and video streams which can be reproduced by vehicle entertainment system through loudspeakers and video monitors. Unit obtains control data from the mentioned vehicle entertainment system and provides status and playback data to the vehicle entertainment system.

### BACKGROUND OF INVENTION

The present invention relates to vehicle entertainment systems which provide audio and video entertainment information to vehicle driver and passengers.

In recent years vehicle entertainment systems are usually based on a head unit for control and status display, audio amplifier and loudspeakers, video display block or unit. Besides of analog information received for example from AM or FM radio tuner or from TV tuner, other entertainment information stored mostly in a digital form in CD or MD or DVD discs or flash memory cards. To provide a longer entertainment time CD/DVD changers are used.

Vehicle interior space is limited and provides few possible mounting locations for CD/DVD changers. Because of the above reason popular models of CD/DVD changers make use of 6 to 8 discs and very rear more than 12.

Because of their nature CD/DVD players are sensitive to shock and vibration that are common in a vehicle. This requires serious protection means from shock and vibration. Protection may include mechanical means like springs, air or oil shock absorbers, as well as electronic means such as memory buffers. All these means make CD/DVD changer construction bigger, more complex, heavier and more expensive.

Recently digital entertainment content is becoming popular. Music, stories, lessons, still and motion pictures, videos are available in a digital form in stores, schools and Internet. To listen and view this content in a car user can burn CD or DVD disc or use flash cards for small size content. Entertainment time is limited to CD/DVD disc size and available amount of discs in a CD/DVD changer.

User may create disc storage in a car and change discs manually. Unfortunately disc storage consumes vehicle interior space and changing discs manually by car driver during driving may cause safety hazard.

### SUMMARY OF INVENTION

In recent years great achievements have been made in a mobile computing field. Now slim and light weight hard disks are available that are suitable to work in extended temperature range and with vibration specification comparable with car CD/DVD player specification even without external shock absorbers.

Development and wide use of USB high speed standard made possible quick transfer of large digital data amount from computer to external storage devices such as external hard disk. Data transfer speed to hard disk using USB connection may be faster than speed of burning CD or DVD disc.

Recently available mobile hard disks offer data storage size bigger than a cassette of 12 DVD discs and substantially bigger than a cassette of 12 CD discs.

Cassette with one mobile hard disk may be smaller in size and lighter in weight then a cassette with 6 DVD or CD discs.

Use of interface compatible with existing CD/DVD changer provides the possibility of direct replacement of CD/DVD changer by a media player unit based on removable hard disk.

Use of interface compatible with existing in-dash CD/DVD deck gives a possibility of direct replacement of in-dash CD/DVD deck by a media player unit based on removable hard disk for manufacturers of vehicle entertainments systems or units.

### BRIEF DESCRIPTION OF DRAWINGS

FIG. 1 is a structural view of a media player unit based on removable hard disk.

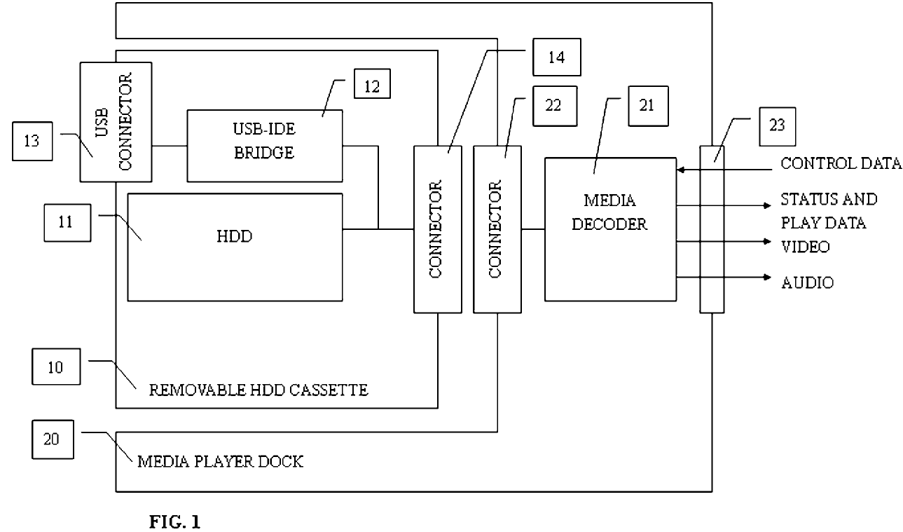

### DETAILED DESCRIPTION

Removable cassette 10 carries hard disk drive 11.

USB connector 13 is used to transfer data from personal computer to hard disk drive 11 using USB-to-IDE bridge 12.

Connector 14 located in removable cassette 10 is used to mate with connector 22 located in a media player dock 20 which is mounted inside a vehicle.

Digital media data from hard disk drive 11 read by media decoder 21 through connectors 14 and 22.

After decoding from digital media data, audio and video streams are output by media decoder 21 in digital or analog form through interface 23 to vehicle entertainment system.

Vehicle entertainment system sends control data such play, pause, stop or other commands to media decoder 21 through interface 23.

Media decoder 21 provides status information and play information to vehicle entertainment system through interface 23.

1. Vehicle media player unit, comprising:
a media player dock mounted inside a vehicle with media decoder, connector for removable cassette and interface to vehicle entertainment system,
a removable cassette with a hard disc, connector to media player dock, USB-to-IDE bridge circuit and USB connector for updating information on a hard disc from computer.

2. Vehicle media player unit, comprising:
a media player dock mounted inside a vehicle with media decoder, USB connector for removable cassette and interface to vehicle entertainment system,
a removable cassette with a hard disc, USB-to-IDE bridge circuit, USB connector to media player dock which also used for updating information on a hard disc from computer.

3. Vehicle media player unit of claim 1 having car CD/DVD disc changer compatible interface and used to replace CD/DVD disc changer.

4. Vehicle media player unit of claim 1 having car CD/DVD deck compatible interface and used to replace CD/DVD deck inside of in-dash player.

5. Vehicle media player unit of claim 2 having car CD/DVD disc changer compatible interface and used to replace CD/DVD disc changer.

6. Vehicle media player unit of claim 2 having car CD/DVD deck compatible interface and used to replace CD/DVD deck inside of in-dash player.
